(19) United States
(12) Patent Application Publication
(10) Pub. No.: US 2008/0242827 A1
(43) Pub. Date: Oct. 2, 2008

(54) Method for producing omni-meta aromatic polysulfonamide fiber

(75) Inventors: Xiaofeng Wang, Shanghai (CN); Jun Li, Shanghai (CN); Ronghua Yuan, Shanghai (CN); Haifeng Wang, Shanghai (CN); Shunxing Lu, Shanghai (CN); Shenghui Chen, Shanghai (CN); Jicheng Chang, Shanghai (CN); Qingrong Song, Shanghai (CN)

Correspondence Address: NIXON & VANDERHYE, PC, 901 NORTH GLEBE ROAD, 11TH FLOOR, ARLINGTON, VA, 22203, US

(73) Assignee: SHANGHAI TANLON FIBER CO.,LTD., Shanghai (CN)

(21) Appl. No.: 11/984,019

(22) Filed: Nov. 13, 2007

(30) Foreign Application Priority Data
Mar. 26, 2007 (CN) 200710038474.5

(51) Int. Cl. C08G 75/20

(52) U.S. Cl. 528/172

(57) ABSTRACT

The invention relates to a method of preparing omni-meta aromatic polysulfonamide fiber which comprises three steps of preparing spinning dope, wet spinning and post treating. The said step of preparing spinning dope comprises the following steps: (1) dissolving 3,3′-diaminodiphenyl sulphone in a polar organic solvent and cooling it to −20˜20° C.; (2) adding m-phthaloyl chloride of the same mole of the 3,3′-diaminodiphenyl sulphone to carry out a polymerization reaction; (3) then adding an inorganic base of the same mole of 3,3′-diaminodiphenyl sulphone to neutralize the hydrogen chloride produced during the polymerization reaction. The spinning dope thus prepared has a polymer solid content of 10%-20%. The fiber prepared according to the method in the present invention has a greatly improved crimpability, and evidently increased elongation at break comparing with the conventional aromatic polysulfonamide fiber, so that the spinnability of resultant yarn is improved.

### TECHNICAL FIELD

The present invention relates to a method for producing a chemical fiber, more particularly, to a method for producing an omni-meta aromatic polysulfonamide fiber.

### BACKGROUND ART

Aromatic polysulfonamides have excellent heat resistance and flame resistance as well as excellent high-temperature electrical insulation property, so that they are used to prepare fireproof and flame resistant materials and high-temperature insulation materials, such as fibers etc.

Chinese patent No. 1176256C disclosed a method for producing aromatic polysulfonamide fiber, which includes low-temperature solution polymerizing with paraphthaloyl chloride (TPC) after mixing 5%-50% of 3,3′-diaminodiphenyl sulphone (3′3-DDS) and 50%-95% of 4,4′-diaminodiphenyl sulphone (4,4′-DDS), and wet spinning to obtain the aromatic polysulfonamide fiber. The content of meta-position aromatic amido bond is 5%-50% and the content of para-position aromatic amido bond is 50%-95%.

The aromatic polysulfonamide fiber produced by the method has the advantages of good strength and small thermal shrinkage. But its weakness includes little elongation at break, bad crimpability, thereby sometimes affecting the spinnability of the fiber in the yarn formation process, increasing the fragility of yarn and decreasing the strength of resultant yarn.

### SUMMARY OF THE INVENTION

In order to solve the above problems, the present invention provides a method for producing omni-meta aromatic polysulfonamide fiber, which combines suitable polymerization, spinning and post treatment processes to produce omni-meta aromatic polysulfonamide fiber. And the method can adjust the molecular structure of the polymer macromolecule, improve the crimpability and elongation at break of the fiber and increase the spinnability of resultant yarn.

To achieve the above objects, the method for producing omni-meta aromatic polysulfonamide fiber according to the invention comprises three steps of preparing spinning dope, wet spinning and post treating. 3,3′-diaminodiphenyl sulphone and m-phthaloyl chloride (IPC) as the raw materials are dissolved in an organic solvent, such as N-methylpyrrolidone, N,N-dimethylacetamide, or N,N-dimethylformamide, etc. The polymerization of the above solution is performed by the method of low-temperature solution polymerization. At the completion of the polymerization, an inorganic base is added to neutralize the hydrogen chloride produced during the reaction. Generally, the said inorganic base may be calcium hydroxide; it may also be Lithium hydroxide or Magnesium hydroxide, or the oxides of calcium, lithium or magnesium. The polymer solid content in the prepared spinning dope is 10%-20%. The wet spinning is performed for the spinning dope. The coagulation bath in the wet spinning consists of a polar organic solvent, such as N-methylpyrrolidone, N,N-dimethylacetamide, N,N-dimethylformamide etc., water and one of the chlorides of calcium, lithium and magnesium. The freshly formed filament is obtained by subjecting the solidified fiber with prestretching, water washing and drying. Then the resultant omni-meta aromatic polysulfonamide fiber is obtained by subjecting the freshly formed filament with the post treatments of high temperature stretching, heat setting, oiling, drying and crimping.

The spinning dope is prepared as following: dissolving 3′3-DDS in a polar organic solvent such as N,N-dimethylacetamide (DMAc), and cooling to −20˜20° C.; then adding IPC of the same mole of 3′3-DDS with a controlled addition speed to maintain the polymerization temperature in the range of −10˜30° C.; the reaction is continued for more than 30 min after IPC is completely added, and an inorganic base of a same mole of 3′3-DDS is added to neutralize the hydrogen chloride generated in the reaction, the temperature of the neutralization reaction is controlled at 20-80° C. and the neutralization reaction time is controlled at 1˜24 hours after the inorganic base is completely added; the alkali chloride and water generated in the neutralization reaction are dissolved in the slurry, and spinning dope having a polymer solid content of 10%-20% is thus prepared.

The process of the wet spinning is as following: with the conventional direct or turnable wet spinning equipments, the above spinning dope is measured by a metering pump, filtered by a filter and sprayed into a coagulation bath through a spinneret. The number of the nozzle holes on the spinneret is 500-30,000; the diameter of the nozzle holes is generally 0.05-0.15 mm; and the spinning speed is 3˜30 m/min. The composition of the coagulation bath is: 15%˜60% of polar organic solvent (such as DMAc), 0˜60% of metal halide (such as calcium chloride), and the remaining amount of water (all by mass percent). The temperature of the coagulation bath is controlled at 0˜90° C. After obtaining the yarns from coagulation, the yarns are transferred into a prestretching tank. The composition of the stretch bath is: 10%˜50% of polar organic solvent (such as DMAc), 0˜20% of metal halide (such as calcium chloride), and the remaining amount of water (all by mass percent). The temperature of the stretch bath is controlled at 30˜100° C., the prestretch ratio is controlled at 1˜5 times, preferably 1.5˜3 times. Subsequently, water washing is performed in pure water of 40˜800, and the freshly formed filaments are obtained by drying at 100˜260° C.

The post treating process is as following: the freshly formed filament is stretched in a 250˜450° C. hot tube by a stretch ratio of 1˜3 times, preferably 1.5˜2 times. The stretched filament is then stabilization processed with a heat setting machine at 250˜450° C. for 0.5˜5 min, preferably 1˜2 min. Afterwards, the filament is oiled with a cation-type preparation agent by an oiling ratio of 0.3˜0.9%. The oiled filament is dried at 100˜150° C. in an air oven to control the water content in the dried filament at 4˜20%. And then, crimping is performed under the condition of steam wetting. The crimping temperature is controlled at 100˜260° C., preferably 150˜200° C. Finally, after cool setting, the filament is cut with a common cutter to obtain the omni-meta aromatic polysulfonamide fiber.

In the present invention, the omni-meta aromatic polysulfonamide molecule is obtained by the low-temperature solution polymerization with 3′3-DDS and IPC as monomers. The macromolecule structure contains all meta position type aromatic amido molecular bonds and sulphone groups. Comparing with the molecular structure of conventional aromatic polysulfonamide, the difference is the change of the form of the meta position and para position mixed type aromatic amido molecular bonds in the molecular structure of the conventional aromatic polysulfonamide. Omni-meta aromatic polysulfonamide fiber is obtained through wet spinning from the polymer with the molecular structure according to the present invention. The fiber has the advantages of great elongation at break and good crimpability property.

The fiber prepared according to the present invention still has the good heat resistance and flame resistance, and further has greatly improved crimpability than the conventional aromatic polysulfonamide fiber, has evidently increased elongation at break, and has improved spinnability of resultant yarns so that it is more applicable for the industrial materials such as dust removing filter etc, as well as protective suits such as heatproof work suits and fire protection suits, and electrical insulating materials, etc.

### EMBODIMENT OF THE INVENTION

### Example 1

170 parts of dry 3′3-DDS is dissolved in 1080 parts of newly distilled dry DMAc, and cooled to −15C. Then 140 parts of refined granular IPC is added. The polymerization temperature is controlled within the range of −15˜0° C. and the reaction is continued at 5˜15° C. for 90 min after all IPC is added. Then 51.5 parts of calcium hydroxide are added to perform a neutralization reaction under temperature of 60±5° C. for 10 hours. A spinning dope having a polymer solid content of 18% is thus prepared. The above spinning dope is measured by a metering pump, filtered by a filter and sprayed into a coagulation bath through a spinneret. The number of the nozzle holes on the spinneret is 3,000; the diameter of the nozzle holes is 0.06 mm; and the spinning speed is 5.5 m/min. The composition of the coagulation bath is: DMAc 60%, calcium chloride 3.5%, and water 36.5% (all by mass percent). The temperature of the coagulation bath is 10° C. After obtaining the yarns from coagulation, the yarns are transferred into a prestretching tank. The composition of the stretch bath is: DMAc 20%, calcium chloride 1%, and water 79% (all by mass percent). The temperature of the stretch bath is 50° C. and the prestretch ratio is 2.5 times. Subsequently, water washing is performed in pure water of 80° C., and the freshly formed filaments are obtained by drying at 105° C. The freshly formed filament is stretched in a hot tube of 300° C. by a stretch ratio of 1.5 times and then stabilization processed with a heat setting machine at 250° C. for 1 min. Afterwards, the filament is oiled with a cation-type preparation agent by an oiling ratio of 0.5%. The oiled filament is dried at 110° C. in an air oven to get a water content of 5% in the dried filament. And then, crimping is performed under the condition of steam wetting. The crimping temperature is 110° C. Finally, after cool setting, the filament is cut with a common cutter to obtain the cotton type omni-meta aromatic polysulfonamide fiber which has a fiber number of 1.66 dtex and a cut length of 38 mm.

### Example 2

105.9 parts of dry 3′3-DDS is dissolved in 1080 parts of newly distilled dry N,N-dimethyl formamide (DMF), and cooled to 0° C. Then 87.2 parts of refined granular IPC is added. The polymerization temperature is controlled within the range of 0-10° C. and the reaction is continued at 5-20° C. for 60 min after all IPC is added. Then 24.3 parts of calcium oxide are added to perform a neutralization reaction under temperature of 50±5° C. for 20 hours. A spinning dope having a polymer solid content of 13% is thus prepared. The above spinning dope is measured by a metering pump, filtered by a filter and sprayed into a coagulation bath through a spinneret. The number of the nozzle holes on the spinneret is 3,000; the diameter of the nozzle holes is 0.06 mm; and the spinning speed is 6.5 m/min. The composition of the coagulation bath is: DMF 50%, calcium chloride 4.0%, and water 46% (all by mass percent). The temperature of the coagulation bath is 0° C. After obtaining the yarns from coagulation, the yarns are transferred into a prestretching tank. The composition of the stretch bath is: DMF 25%, calcium chloride 0%, and water 75% (all by mass percent). The temperature of the stretch bath is 40° C. and the prestretch ratio is 2.2 times. Subsequently, water washing is performed in pure water of 80° C., and the freshly formed filaments are obtained by drying at 105° C. The freshly formed filament is stretched in a hot tube of 285° C. by a stretch ratio of 1.5 times and then stabilization processed with a heat setting machine at 220° C. for 1 min. Afterwards, the filament is oiled with a cation-type preparation agent by an oiling ratio of 0.5%. The oiled filament is dried at 110° C. in an air oven to get a water content of 5% in the dried filament. And then, crimping is performed under the condition of steam wetting. The crimping temperature is 110° C. Finally, after cool setting, the filament is cut with a common cutter to obtain the cotton type omni-meta aromatic polysulfonamide fiber which has a fiber number of 1.66 dtex and a cut length of 38 mm.

### Example 3

170 parts of dry 3′3-DDS is dissolved in 1080 parts of newly distilled dry DMAc, and cooled to 15° C. Then 140 parts of refined granular IPC is added. The polymerization temperature is controlled within the range of 15˜30° C. and the reaction is continued at 15˜30° C. for 45 min after all IPC is added. Then 33.3 parts of lithium hydroxide are added to perform a neutralization reaction under temperature of 70±5° C. for 2 hours. A spinning dope having a polymer solid content of 18% is thus prepared. The above spinning dope is measured by a metering pump, filtered by a filter and sprayed into a coagulation bath through a spinneret. The number of the nozzle holes on the spinneret is 3,000; the diameter of the nozzle holes is 0.075 mm; and the spinning speed is 6.0 m/min. The composition of the coagulation bath is: DMAc 60%, lithium chloride 5.0%, and water 35% (all by mass percent). The temperature of the coagulation bath is 10° C. After obtaining the yarns from coagulation, the yarns are transferred into a prestretching tank. The composition of the stretch bath is: DMAc 30%, lithium chloride 1%, and water 69% (all by mass percent). The temperature of the stretch bath is 50° C. and the prestretch ratio is 2.5 times. Subsequently, water washing is performed in pure water of 80° C., and the freshly formed filaments are obtained by drying at 105° C. The freshly formed filament is stretched in a hot tube of 300° C. by a stretch ratio of 1.5 times and then stabilization processed with a heat setting machine at 250° C. for 1 min. Afterwards, the filament is oiled with a cation-type preparation agent by an oiling ratio of 0.5%. The oiled filament is dried at 110° C. in an air oven to get a water content of 7% in the dried filament. And then, crimping is performed under the condition of steam wetting. The crimping temperature is 110° C. Finally, after cool setting, the filament is cut with a common cutter to obtain the cotton type omni-meta aromatic polysulfonamide fiber which has a fiber number of 2.22 dtex and a cut length of 51 mm.

### Comparative Example 1

The cotton type aromatic polysulfonamide fiber is prepared according to the method disclosed in the foresaid patent CN1176256C. In the fiber molecular structure, the content of the meta-position aromatic amido bonds is 25%, the content of the para-position aromatic amido bonds is 75%, and the fiber number is 1.66 dtex and the cut length is 38 mm.

### Comparative Example 2

The medium length type aromatic polysulfonamide fiber is prepared according to the method disclosed in the foresaid patent CN1176256C. In the fiber molecular structure, the content of the meta-position aromatic amido bonds is 25%, the content of the para-position aromatic amido bonds is 75%, and the fiber number is 2.22 dtex and the cut length is 51 mm.

Comparing the properties of aromatic polysulfonamide fibers prepared according to the examples of the present invention with those prepared according to the methods disclosed in the patent of CN1176256C, the detailed results are shown in the following table:

| | Fiber Number | Strength | Elongation at | | |
|---|---|---|---|---|---|
| Items | (dtex) | (cN/dtex) | Break (%) | Crimpability | Crimp Recovery |
| Example 1 | 1.66 | 2.7 | 32.6 | 15.47 | 10.16 |
| Example 2 | 1.66 | 2.7 | 31.9 | 16.12 | 10.75 |
| Example 3 | 2.22 | 2.7 | 32.4 | 15.62 | 10.47 |
| Comparative | 1.66 | 3.0 | 23.7 | 11.17 | 7.06 |
| Example 1 | | | | | |
| Comparative | 2.22 | 3.0 | 22.7 | 8.20 | 6.08 |
| Example 2 | | | | | |

As shown in the above table, the fibers prepared according to the present invention has a greatly improved crimpability property and evidently increased elongation at break comparing with the aromatic polysulfonamide fibers prepared according the method disclosed in CN1176256C.

1. A method for producing omni-meta aromatic polysulfonamide fiber, comprising three steps of preparing spinning dope, wet spinning and post treating, characterized in that, the said step of preparing spinning dope comprises the following steps:
(1) dissolving 3,3′-diaminodiphenyl sulphone in a polar organic solvent and cooling it to −20˜20□;
(2) adding m-phthaloyl chloride of the same mole of the 3,3′-diaminodiphenyl sulphone to carry out a polymerization reaction;
(3) then adding an inorganic base of the same mole of the 3,3′-diaminodiphenyl sulphone to neutralize the hydrogen chloride produced during the said polymerization reaction; the spinning dope thus prepared has a polymer solid content of 10%-20%.

2. The method for producing omni-meta aromatic polysulfonamide fiber according to claim 1, characterized in that, the said polar organic solvent is one selected from the group consisting of N-methyl pyrrolidone, N,N-dimethyl acetamide and N,N-dimethyl formamide.

3. The method for producing omni-meta aromatic polysulfonamide fiber according to claim 1, characterized in that, the said inorganic base is one selected from the group consisting of calcium hydroxide, lithium hydroxide, magnesium hydroxide, calcium oxide, lithium oxide and magnesium oxide.

4. The method for producing omni-meta aromatic polysulfonamide fiber according to claim 1, characterized in that, the adding speed of m-phthaloyl chloride is controlled so that the polymerization temperature is in the range of −10˜30° C.

5. The method for producing omni-meta aromatic polysulfonamide fiber according to claim 4, characterized in that, the reaction continues for more than 30 minutes at −10˜30° C. after the m-phthaloyl chloride is added completely.

6. The method for producing omni-meta aromatic polysulfonamide fiber according to claim 1, characterized in that, the temperature of the neutralization reaction is controlled at 20˜80° C.; and the reaction time of the neutralization reaction is 1˜24 hours after the inorganic base is added completely.
